(19) United States
(12) Patent Application Publication
(10) Pub. No.: US 2003/0115359 A1
(43) Pub. Date: Jun. 19, 2003

(54) Network relay apparatus, network system, and network relay method

(76) Inventors: Yasuhiro Ishibashi, Ome-shi (JP); Takero Kobayashi, Ome-shi (JP)

Correspondence Address: Pillsbury Winthrop LLP, Intellectual Property Group, Suite 2800, 725 South Figueroa Street, Los Angeles, CA, 90017-5406, US

(21) Appl. No.: 10/237,343

(22) Filed: Sep. 9, 2002

(30) Foreign Application Priority Data
Dec. 13, 2001 (JP) 2001-380163

(51) Int. Cl. G06F 15/173

(52) U.S. Cl. 709/238

(57) ABSTRACT

After receiving a first packet from a personal computer, an access point on a shop side forms a second packet containing the first packet in its payload and transmits the formed second packet to an access point on a head office side via the Internet. After receiving the second packet from the Internet, the access point on the head office side extracts from the payload of the received second packet the first packet that was formed by the access point on the shop side and outputs the extracted first packet to a server computer.

### CROSS-REFERENCE TO RELATED APPLICATIONS

This application is based upon and claims the benefit of priority from prior Japanese Patent Application No. 2001-380163, filed Dec. 13, 2001.

### BACKGROUND OF THE INVENTION

1. Field of the Invention

The present invention relates to a network relay apparatus, network system, and network relay method suitable to be applied to a case wherein, e.g., an Internet connection service is provided to a plurality of local shops and, more particularly, to a network relay apparatus, network system, and network relay method that can manage all the customers of the plurality of local shops by a single server computer by using physical addresses corresponding to the computers of the respective customers.

2. Description of the Related Art

The Internet has come into widespread use in recent years, and companies and individuals publish information or provide various services utilizing the Internet. Along with this use, Internet connection services have been offered. In this service, for example, a local area network (LAN) or Ethernet is provided in one service location, and a customer at the service location utilizes a computer having a connection to the LAN to access the Internet.

Each service location includes a server computer connected to the LAN, and a gateway/router that is also connected to the LAN. The gateway/router is connected to the Internet, which in turn provides the connection for the server computer and the customer computers to the Internet.

Each time a customer computer transmits or receives data, it acquires an Internet Protocol (IP) address from the server computer to transmit and receive data via the Internet. This process is required because in order to communicate via the Internet, all Ethernet packets transmitted to and received from each customer computer must pass through the server computer. The server computer utilizes a media access control (MAC) address in the Ethernet packets to determine which customer computer at the service location is to receive and is transmitting an Ethernet packet.

The server computer utilized at a service location requires high processing capabilities, and a high-performance computer system is typically employed. Because high-performance computer systems are expensive, an increase in the number of service locations by an operator considerably increases the overall operating costs.

The operating costs would be greatly minimized if a single server computer is utilized to provide Internet access to customer computers at a number of different service locations. To implement this configuration, an Ethernet packet transmitted to and received from each customer computer must be transferred to the single server computer over the Internet. However, there is no protocol for transmitting and receiving an Ethernet packet containing a MAC address over the Internet.

Additionally, in order to use a destination MAC address in an Ethernet packet transmitted by each customer computer as the MAC address of the single server computer, at least two locations, the single server computer and each service location, which are connected to each other via the Internet, must virtually form one subnet.

### BRIEF SUMMARY OF THE INVENTION

The present invention has been made in consideration of the above situations, and has as its object to provide a network relay apparatus, network system, and network relay method that can manage all the users of a plurality of local shops by a single server computer by using physical addresses corresponding to the computers of the respective users.

To achieve the above object, according to a first aspect of the present invention, there is provided a network relay apparatus that performs data relay between a first network in which data is transmitted/ received by using a packet in a first form constructed by a first header and a first information field, and a second network in which data is transmitted/received by using a packet in a second form constructed by a second header and a second information field. A containment module is provided to contain in the second information field the packet in the first form received from the first network. A transmission module is provided to transmit to the second network the packet in the second form in which the second information field contains the packet in the first form.

According to a second aspect of the present invention, there is provided a network relay apparatus that performs data relay between a first network in which data is transmitted/received by using a packet in a first form constructed by a first header and a first information field and a second network in which data is transmitted/received by using a packet in a second form constructed by a second header and a second information field. An extraction module is provided to extract the packet in the first form from the second information field of the packet in the second form received from the second network. A transmission module is provided to transmit to the first network the packet in the first form extracted from the second information field of the packet in the second form.

The present invention can directly transfer, e.g., a MAC address for the Ethernet via the Internet and can process, as one subnet, a plurality of remote places that are connected to each other via the Internet. For this reason, the customers of the respective personal computers can be unitarily managed at a remote place by using actual MAC addresses.

Additional objects and advantages of the present invention will be set forth in the description which follows, and in part will be obvious from the description, or may be learned by practice of the present invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the present invention and, together with the general description given above and the detailed description of the embodiments given below, serve to explain the principles of the present invention.

FIG. 1 is a block diagram showing a schematic arrangement of a network system according to an embodiment of the present invention;

FIG. 2 is a block diagram showing a logical stack arrangement of access points respectively installed in a head office and each shop in the network system according to the embodiment;

FIG. 3 is a first view showing an example in which an access point in the network system according to the embodiment forms an IP packet containing an Ethernet packet in its payload;

FIG. 4 is a first view showing an example in which an access point in the network system according to the embodiment extracts the Ethernet packet from the payload of the IP packet;

FIG. 5 is a block diagram showing the logical stack arrangement of access points respectively installed in a head office and each shop in the network system according to the embodiment;

FIG. 6 is a second view showing an example in which an access point in the network system according to the embodiment forms an IP packet containing an Ethernet packet in its payload;

FIG. 7 is a second view showing an example in which an access point in the network system according to the embodiment extracts the Ethernet packet from the payload of the IP packet;

FIG. 8 is a flowchart showing an operation procedure of an access point when the network system according to the embodiment transmits an Ethernet packet via the Internet; and

FIG. 9 is a flowchart showing an operation procedure of an access point when the network system according to the embodiment receives an Ethernet packet via the Internet.

### DETAILED DESCRIPTION OF THE INVENTION

An embodiment of the present invention will be described below with reference to the accompanying drawings.

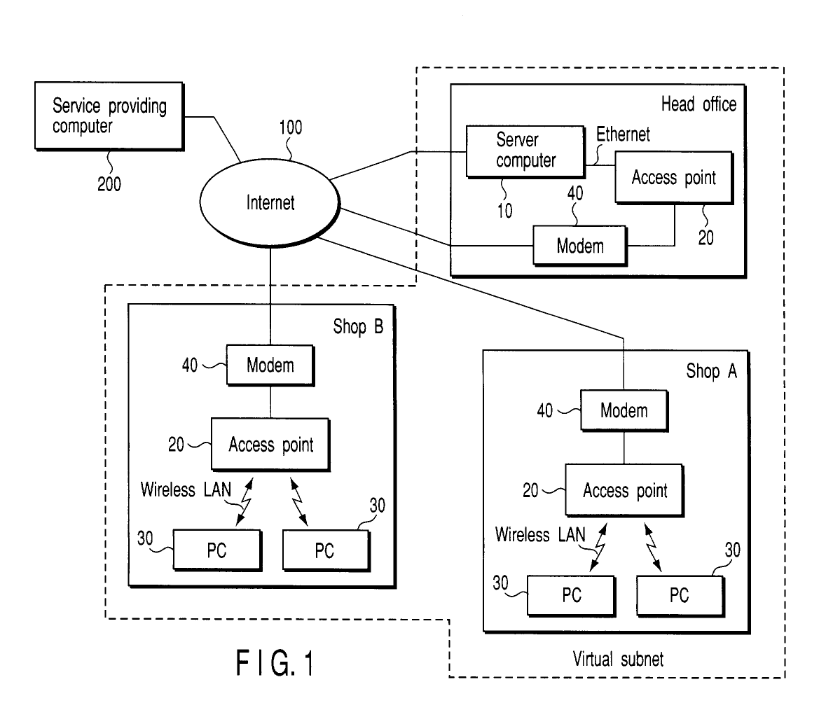

FIG. 1 is a block diagram showing a schematic arrangement of a network system according to the embodiment of the present invention.

The network system offers a service for providing an environment for, e.g., receiving a service provided by a service providing computer 200, i.e., connecting to the Internet 100. As shown in FIG. 1, a plurality of shops for customers that serve as service locations and a head office for unitarily managing the customers are remotely provided in this network system. Each shop is connected to the head office via the Internet 100.

Each of the plurality of local shops has a modem 40 and access point 20. The modem 40 is a modulation/demodulation unit for converting a digital signal from the access point 20 into an analog signal and transmitting the resultant signal to the Internet 100, and converting an analog signal from the Internet 100 into a digital signal and transmitting the resultant signal to the access point 20. The access point 20 is a relay unit for forming a wireless LAN service area within a predetermined geographical range and controlling relay between the formed wireless LAN and the Internet 100. A personal computer 30 used by a customer is to be connected to the Internet 100 by wirelessly connecting to an access point 20 within a wireless LAN service area formed by this access point 20.

The head office has a server computer 10 in addition to a modem 40 and access point 20 that are similar to those installed in each shop. The server computer 10 functions as a router, which transmits to the Internet 100 IP packets containing the transmission data of the personal computer 30 used by a customer and receives from the Internet 100 IP packets containing the reception data of the personal computer 30, on the basis of a principle to be described later. The server computer 10 executes customer management, e.g., accounting by using a MAC address contained in an Ethernet packet that is to be transmitted to/received from the personal computer 30 for data transmission/reception via the Internet 100.

The network system in this embodiment has the following characteristic. The head office and each shop that are remotely arranged and connected to each other via the Internet 100 virtually form one subnet so that the server computer 10 can manage customers altogether by using the MAC addresses of the personal computers 30, as described above. This configuration will be described in detail below.

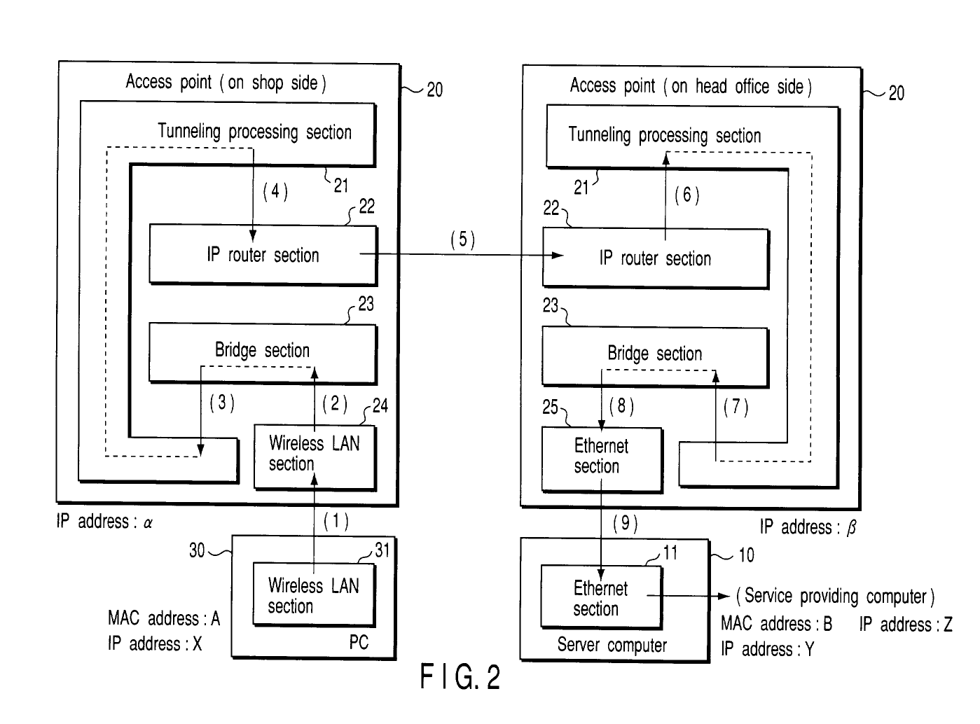

FIG. 2 is a block diagram showing the logical stack arrangement of the access point 20 installed at each of the head office and shops.

As shown in FIG. 2, the access point 20 installed in each shop has a tunneling processing section 21, IP router section 22, bridge section 23, and wireless LAN section 24. The access point 20 installed at the head office has an Ethernet section 25 instead of the wireless LAN section 24. Each section is implemented by software as a program that describes the operation procedure of a CPU included in the access point 20.

Assuming that the personal computer 30 at a shop communicates with the service providing computer 200 via the Internet 100, the operation of each section of the access points 20 in this case will be described. Note that the MAC address and IP address of the personal computer 30 are respectively represented as “A” and “X”, and the MAC address and IP address of the server computer 10 are respectively represented as “B” and “Y”. The IP address of the service providing computer 200 is represented as “Z”, and the IP addresses of the access points 20 on the shop side and head office side are respectively represented as “α” and “β”. The IP address “X” of the personal computer 30 is temporarily assigned by the server computer 10.

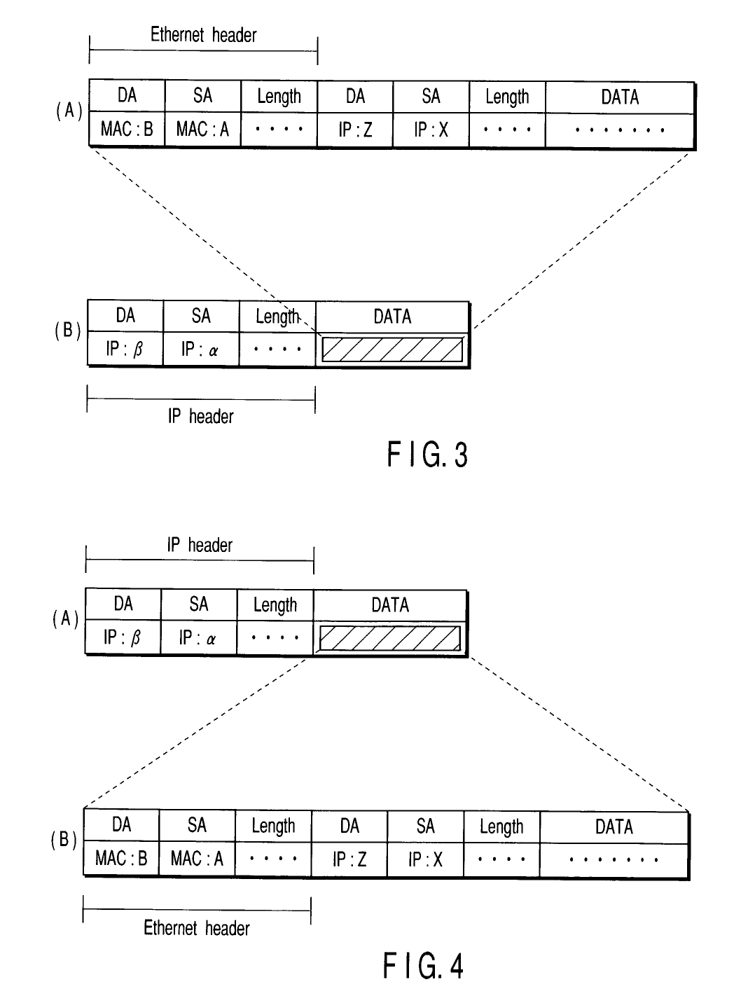

An Ethernet packet transmitted from a wireless LAN section 31 of the personal computer 30 is received by the wireless LAN section 24 of the access point 20 on the shop side ((1) in FIG. 2). FIG. 3 is a view showing the content of the Ethernet packet (A) transmitted/received at this time.

In the following description, a field that contains control data such as a data length is referred to as a header, and a field, excepting the header, which contains so-called user data is referred to as a payload (information containing field).

As shown in FIG. 3, an Ethernet header contains the MAC address “B” of the server computer 10 as Destination Address (DA) and the MAC address “A” of the personal computer 30 as Source Address (SA). The payload of the Ethernet packet contains an IP packet addressed to the service providing computer 200, which is transmitted to the Internet 100. An IP header that is at the head of the IP packet contains the IP address “Z” of the server computer as Destination Address and the IP address “X” of the personal computer 30 as Source Address.

In the prior art, the Ethernet header containing the MAC addresses of the server computer 10 and personal computer 30 has been separated from the packet, and only the residual IP packet has been transmitted to the Internet 100. That is, customer management using the MAC address cannot be performed in the remote server computer 10 connected via the Internet 100. To solve this problem, in this network system, the access point 20 has a mechanism for MAC bridge-connecting remote places that are connected via the Internet 100, so that the remote server computer 10 can manage customers using the MAC address.

After receiving the Ethernet packet from the personal computer 30, the wireless LAN section 24 transfers this packet to the bridge section 23 ((2) in FIG. 2). The bridge section 23 checks Destination Address of the Ethernet header, determines that the received packet should pass the access point 20, and transfers this packet to the tunneling processing section 21 ((3) in FIG. 2).

The tunneling processing section 21 transfers the Ethernet packet received from the bridge section 23 to the IP router section 22 ((4) in FIG. 2). More specifically, the tunneling processing section 21 helps to connect the output of the bridge section 23 to the IP router section 22 as its host and transfers the Ethernet packet to the IP router section 22 as user data.

After receiving the Ethernet packet as user data, the IP router section 22 contains the Ethernet packet in the payload of the IP packet and contains in an IP header the IP address “β” of the access point 20 on the head office side and the IP address “α” of the access point 20 on the shop side as Destination Address and Source Address, respectively. FIG. 3 also shows the content of the IP packet (B) formed at this time. The IP router section 22 then transmits the IP packet to the modem 40 to transmit the packet to the Internet 100 ((5) in FIG. 2).

The IP packet transmitted to the Internet 100 in this manner is transferred to the access point 20 on the head office side via the modem 40, and acquired into the access point 20 at the IP router section 22. FIG. 4 is a view showing the content of the IP packet (A) acquired by the IP router section 22 at this time. The IP router section 22 extracts from the IP packet only the payload, i.e., the Ethernet packet and transfers the extracted packet to the tunneling processing section 21 ((6) in FIG. 2). FIG. 4 also shows the content of the Ethernet packet (B) transferred from the IP router section 22 to the tunneling processing section 21 at this time.

The tunneling processing section 21 transfers to the bridge section 23 the Ethernet packet received from the IP router section 22 ((7) in FIG. 2). The bridge section 23 checks Destination Address of the Ethernet header, determines that this packet should pass the access point 20, and transfers the packet to the Ethernet section 25 ((8) in FIG. 2). The Ethernet section 25 outputs the received Ethernet packet ((9) in FIG. 2).

Since Destination Address of the Ethernet packet is the MAC address “B”, this Ethernet packet is transferred to the server computer 10 at its Ethernet section 11. The server computer 10 then separates the Ethernet header from the packet and transmits only the residual IP packet to the Internet 100. The server computer 10 executes customer management such as accounting by using Destination Address, i.e., the MAC address “A” contained in the separated Ethernet header.

As described above, in this network system, the Ethernet packet containing the MAC address can be transmitted/received via the Internet 100, and the server computer 10 can manage the personal computer 30 at a remote place by using the contained MAC address. Since Destination Address of the IP packet transmitted from the server computer 10 to the Internet 100 is the IP address “Z”, this IP packet is transferred to the service providing computer 200. A response from the service providing computer 200 is transferred to the personal computer 30 via the server computer 10 because Destination Address of this response is the IP address “X” that is assigned by the server computer 10 to the personal computer 30.

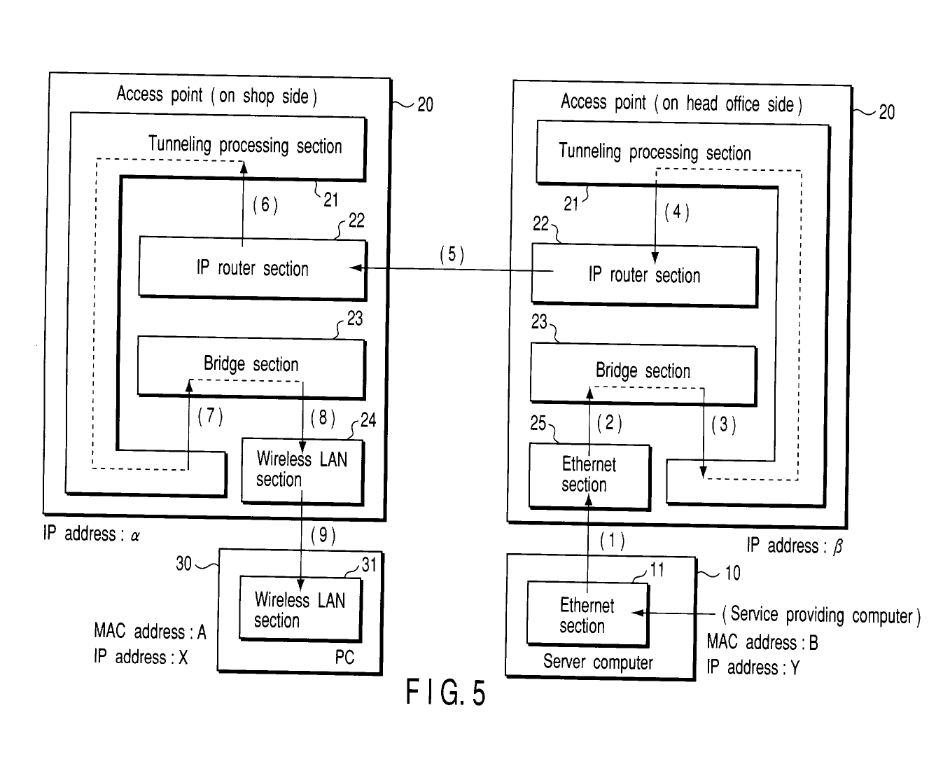

The operation of each section of the access points 20 in a case wherein data returned from the service providing computer 200 is to be transmitted to the personal computer 30 will be described next with reference to FIGS. 5 to 7.

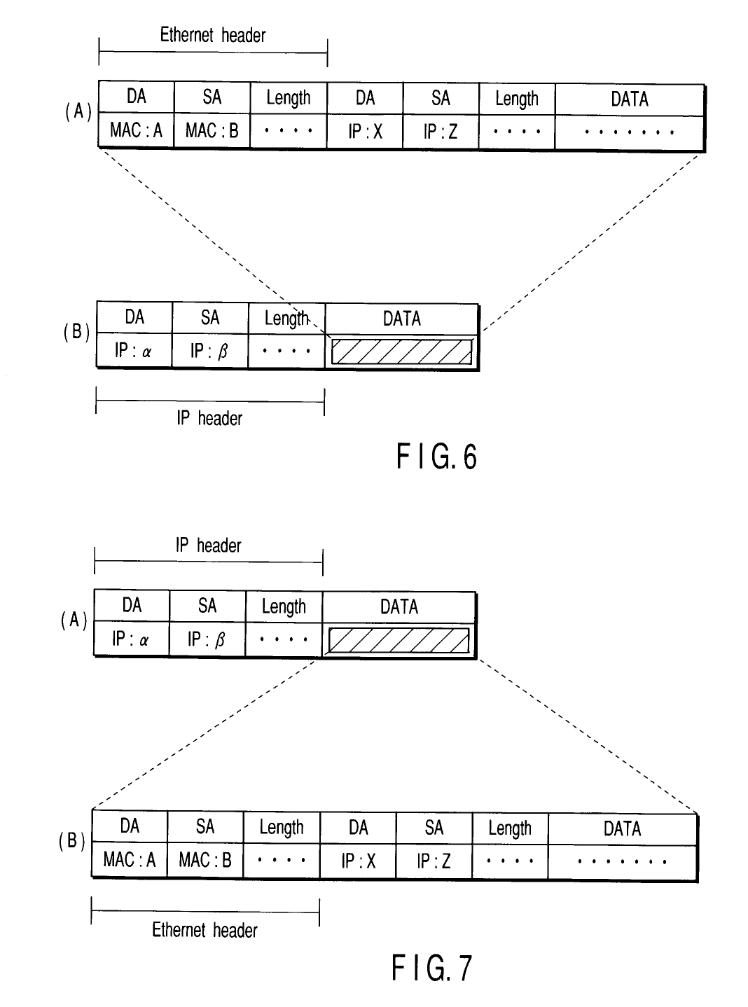

After receiving from the Internet 100 an IP packet transmitted by the service providing computer 200 and addressed to the personal computer 30, the server computer 10 adds to the head of the IP packet an Ethernet header that contains the MAC address “A” of the personal computer 30 and the MAC address “B” of the server computer 10 itself as Destination Address and Source Address, respectively, to form an Ethernet packet, and outputs this packet from the Ethernet section 11 ((1) in FIG. 5). FIG. 6 is a view showing the contents of the Ethernet packet (A) output at this time. The server computer 10 executes customer management such as accounting at this time by using Destination Address, i.e., the MAC address “A” contained in the Ethernet header.

The Ethernet packet output from the Ethernet section 11 of the server computer 10 is received by the Ethernet section 25 of the access point 20 on the head office side. After receiving the Ethernet packet from the server computer 10, the Ethernet section 25 transfers this packet to the bridge section 23 ((2) in FIG. 5). The bridge section 23 checks Destination Address of the Ethernet header, determines that the packet should pass the access point 20, and transfers the packet to the tunneling processing section 21 ((3) in FIG. 5).

As in the above description, the tunneling processing section 21 transfers the Ethernet packet received from the bridge section 23 to the IP router section 22 ((4) in FIG. 5). The IP router section 22 contains the Ethernet packet received as user data in the payload of an IP packet, and contains in an IP header the predetermined IP address “α” of the access point 20 on the shop side and the IP address “β” of the access point on the head office side as Destination Address and Source Address, respectively. FIG. 6 also shows the contents of the IP packet (B) formed at this time. The IP router section 22 then transmits the IP packet to the Internet 100 via the modem 40 ((5) in FIG. 5).

The IP packet transmitted to the Internet 100 in this manner is transferred to the access point 20 on the shop side via the modem 40 and into the access point 20 at the IP router section 22. FIG. 7 is a view showing the contents of the IP packet (A) acquired by the IP router section 22 at this time. The IP router section 22 extracts the Ethernet packet from the IP packet and transfers the Ethernet packet to the tunneling processing section 21, as in the above description ((6) in FIG. 5). FIG. 7 also shows the content of the Ethernet packet (B) transferred from the IP router section 22 to tunneling processing section 21 at this time.

The tunneling processing section 21 transfers to the bridge section 23 the Ethernet packet received from the IP router section 22 ((7) in FIG. 5). The bridge section 23 checks Destination Address of the Ethernet header, determines that this packet should pass the access point 20, and transfers the packet to the wireless LAN section 24 ((8) in FIG. 5). The wireless LAN section 24 transmits the received packet to the personal computer 30 because Destination Address of the Ethernet packet is the MAC address “A” ((9) in FIG. 5).

As described above, in this network system, the head office and each shop that are connected to each other via the Internet 100 are MAC bridge-connected by the access points 20. This configuration makes these remote places, the head office and each shop virtually form one subnet. With this arrangement, the personal computers 30 and server computer 10 can communicate with each other by using the Ethernet packet containing their own MAC addresses.

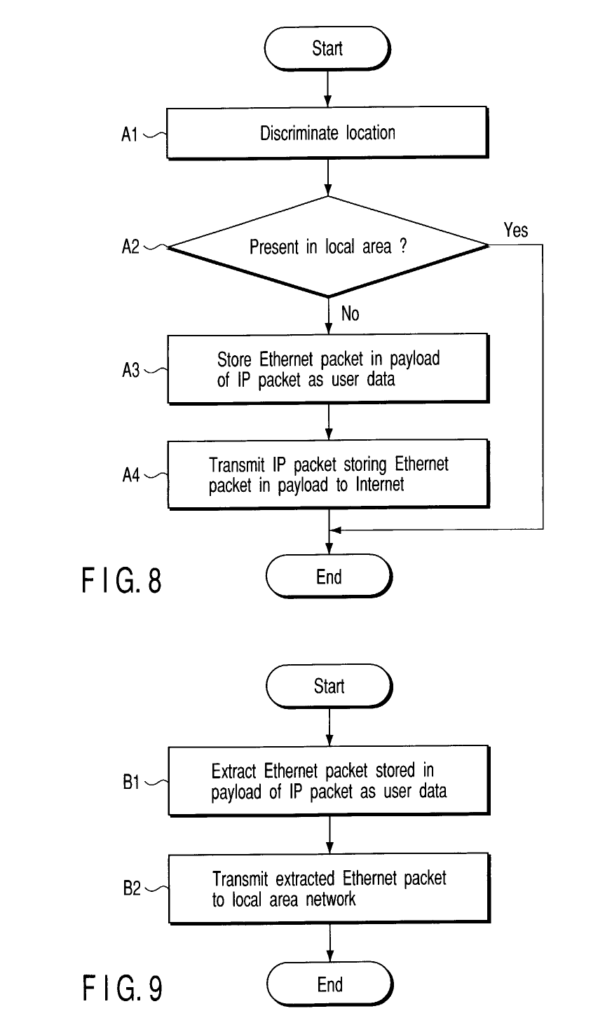

The operation sequence of the access point 20 in this network system will be described next with reference to FIGS. 8 and 9.

FIG. 8 is a flowchart showing the operation sequence of the access point 20 when an Ethernet packet is to be transmitted via the Internet 100.

First, in the access point 20 in this case, the bridge section 23 checks Destination Address contained in the Ethernet header of an Ethernet packet and discriminates its location (step Al). If Destination Address of the packet is not present in a local area (NO in step A2), the bridge section 23 passes the Ethernet packet and transfers it to the tunneling processing section 21.

The Ethernet packet is transferred as user data to the IP router section 22 via the tunneling processing section 21 and contained in the payload of an IP packet at the IP router section 22 (step A3). The IP router section 22 then transmits the IP packet with the payload containing the Ethernet packet to the Internet 100 (step A4).

FIG. 9 is a flowchart showing the operation sequence of the access point 20 when an Ethernet packet is to be received via the Internet 100.

First, in the access point 20 in this case, the IP router section 22 extracts an Ethernet packet contained in the payload of an IP packet and transfers the extracted packet to the tunneling processing section 21 (step B1). The Ethernet packet is transferred to the bridge section 23 via the tunneling processing section 21, and then transmitted from the bridge section 23 to a local area via the wireless LAN section 24 or Ethernet section 25 (step B2).

As has been described above, the access point 20 transmits/receives the Ethernet packet via the Internet 100. That is, the access point 20 realizes a mechanism for MAC bridge-connecting the remote places that are connected to each other via the Internet 100.

Additional advantages and modifications will readily occur to those skilled in the art. Therefore, the invention in its broader aspects is not limited to the specific details and representative embodiments shown and described herein. Accordingly, various modifications may be made without departing from the spirit and scope of the general inventive concept as defined by the appended claims and their equivalents.

What is claimed is:

1. A network relay apparatus that performs data relay between a first network in which data is transmitted/received by using a packet in a first form constructed by a first header and a first information field, and a second network in which data is transmitted/received by using a packet in a second form constructed by a second header and a second information field, comprising:
means for inserting in the second information field the packet in the first form received from the first network; and
means for transmitting to the second network the packet in the second form in which the second information field contains the packet in the first form.

2. An apparatus according to claim 1, wherein
the first header of the packet in the first form contained in the second information field contains a destination media access control (MAC) and a source MAC address.

3. An apparatus according to claim 1, further including means for determining whether the packet in the first form is transmitted to the first network or the second network,
wherein when the packet in the first form is transmitted to the second network in accordance with a determination result by said means for determining, the packet in the first form is contained in the second information field.

4. An apparatus according to claim 2, further including means for determining whether the packet in the first form is transmitted to the first network or the second network,
wherein when the packet in the first form is transmitted to the second network in accordance with a determination result by said means for determining, the packet in the first form is contained in the second information field.

5. A network relay apparatus that performs data relay between a first network in which data is transmitted/received by using a packet in a first form constructed by a first header and a first information field, and a second network in which data is transmitted/received by using a packet in a second form constructed by a second header and a second information field, comprising:
means for extracting the packet in the first form from the second information field of the packet in the second form received from the second network; and
means for transmitting to the first network the packet in the first form extracted from the second information field of the packet in the second form.

6. A network relay apparatus that performs data relay between a first network in which data is transmitted/received by using a packet in a first form constructed by a first header and a first information field, and a second network in which data is transmitted/received by using a packet in a second form constructed by a second header and a second information field, comprising:
means for inserting in the second information field the packet in the first form received from the first network;
means for transmitting to the second network the packet in the second form in which the second information field contains the packet in the first form;
means for extracting the packet in the first form from the second information field of the packet in the second form received from the second network; and
means for transmitting to the first network the packet in the first form extracted from the second information field of the packet in the second form.

7. A network system that forms a plurality of local area networks connected to each other via the Internet into one virtual subnet and manages all computers within the plurality of local area networks by a single server computer by using physical addresses corresponding to the respective computers, comprising:
a plurality of network relay apparatuses, wherein a network relay apparatus is arranged between the Internet and each of the server computer and the plurality of local area networks;
wherein each network relay apparatus includes
means for inserting a packet in a first form, which is constructed by a first header and a first information field and received from one of the local area networks and the server computer, in a second information field of a packet in a second form, which is constructed by a second header and the second information field and transmitted/received via the Internet, and for transmitting the packet in the second form to the Internet, and
means for extracting the packet in the first form from the second information field of the packet in the second form received from the Internet, and for transmitting the packet in the first form to one of the local area networks and the server computer; and
the packet in the first form containing the first header is exchanged between the computers and the server computer that are connected to each other via the Internet.

8. A network relay method that performs data relay between a first network in which data is transmitted/received by using a packet in a first form constructed by a first header and a first information field and a second network in which data is transmitted/received by using a packet in a second form constructed by a second header and a second information field, comprising:
containing in the second information field the packet in the first form received from the first network; and
transmitting to the second network the packet in the second form in which the second information field contains the packet in the first form.

9. A network relay method that performs data relay between a first network in which data is transmitted/received by using a packet in a first form constructed by a first header and a first information field, and a second network in which data is transmitted/received by using a packet in a second form constructed by a second header and a second information field, comprising:
extracting the packet in the first form from the second information field of the packet in the second form received from the second network; and
transmitting to the first network the packet in the first form extracted from the second information field of the packet in the second form.

10. A network relay method that performs data relay between a first network in which data is transmitted/received by using a packet in a first form constructed by a first header and a first information field, and a second network in which data is transmitted/received by using a packet in a second form constructed by a second header and a second information field, comprising:
inserting in the second information field the packet in the first form received from the first network;
transmitting to the second network the packet in the second form in which the second information field contains the packet in the first form;
extracting the packet in the first form from the second information field of the packet in the second form received from the second network; and
transmitting to the first network the packet in the first form extracted from the second information field of the packet in the second form.

11. An Internet Protocol (IP) packet, comprising:
an IP header; and
an IP data section, wherein the IP data section contains a media access control (MAC) packet including a MAC header and a MAC data section.

12. An IP packet according to claim 11, wherein the MAC packet is an Ethernet packet, the MAC header is an Ethernet header, and the MAC data section is an Ethernet data section.

13. A network relay apparatus that performs data relay between a first network in which data is transmitted/received by using a packet in a first form constructed by a first header and a first information field, and a second network in which data is transmitted/received by using a packet in a second form constructed by a second header and a second information field, comprising:
a containment module to contain in the second information field the packet in the first form received from the first network; and
a transmission module to transmit to the second network the packet in the second form in which the second information field contains the packet in the first form.

14. An apparatus according to claim 13, wherein
the first header of the packet in the first form contained in the second information field contains a destination media access control (MAC) address and a source MAC address.

15. An apparatus according to claim 13, further including a determination module to determine whether the packet in the first form is transmitted to the first network or the second network,
wherein when the packet in the first form is transmitted to the second network in accordance with a determination result by the determination module, the packet in the first form is contained in the second information field.

16. An apparatus according to claim 14, further including a determination module to determine whether the packet in the first form is transmitted to the first network or the second network,
wherein when the packet in the first form is transmitted to the second network in accordance with a determination result by said determination module, the packet in the first form is contained in the second information field.

17. A network relay apparatus that performs data relay between a first network in which data is transmitted/received by using a packet in a first form constructed by a first header and a first information field, and a second network in which data is transmitted/received by using a packet in a second form constructed by a second header and a second information field, comprising:
an extraction module to extract the packet in the first form from the second information field of the packet in the second form received from the second network; and
a transmission module to transmit to the first network the packet in the first form extracted from the second information field of the packet in the second form.

18. A method of forming a data packet, comprising:
providing a media access control (MAC) packet having a MAC header and a MAC data section;
providing an Internet Protocol (IP) packet having an IP header and an IP data section; and
storing the MAC packet in the IP data section of the IP packet.

19. A method according to claim 18, wherein the MAC packet is an Ethernet packet, the MAC header is an Ethernet header, and the MAC data section is an Ethernet data section.

20. An access point, comprising:
a bridge section to receive a media access control (MAC) packet having a MAC header and a MAC data section, and to check a destination address in the MAC header;
a tunneling processing section to receive the MAC packet from the bridge section and to forward the MAC packet; and
a router section to receive the MAC packet from the tunneling processing section, to form and transmit an Internet Protocol (IP) packet having an IP header and an IP data section, wherein the MAC packet is stored in the IP data section.

21. An access point according to claim 20, wherein the MAC packet is an Ethernet packet, the MAC header is an Ethernet header, and the MAC data section is an Ethernet data section.

22. An access point, comprising:
a router section to receive an Internet Protocol (IP) packet having an IP header and an IP data section, wherein a media access control (MAC) packet having a MAC header and a MAC data section is stored in the IP data section, and the router section extracts the MAC packet from the IP data section and transmits the MAC packet;
a tunneling processing section to receive the MAC packet from the router section and to forward the MAC packet;
a bridge section to receive the MAC packet from the tunneling processing section, to check a destination address in the MAC header, and to transmit the MAC packet.

23. An access point according to claim 22, wherein the MAC packet is an Ethernet packet, the MAC header is an Ethernet header, and the MAC data section is an Ethernet data section.
